(19) United States
(12) Patent Application Publication
(10) Pub. No.: US 2008/0129876 A1
(43) Pub. Date: Jun. 5, 2008

(54) METHOD OF ACCELERATING AN IMAGE PROCESSING PROCEDURE

(76) Inventor: Chun-Chang Wang, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/684,464

(22) Filed: Mar. 9, 2007

(30) Foreign Application Priority Data
Nov. 30, 2006 (TW) 095144556

(51) Int. Cl. H04N 5/228

(52) U.S. Cl. 348/708; 348/E09.037

(57) ABSTRACT

A method of accelerating an image processing procedure is disclosed. The method is used for a digital image capturing device. The method is used for executing an image processing procedure under a first FPS (Frame Per Second) clock. The method comprises the steps of: using a second FPS clock to design a pulse of a sweep phase and a pulse of a vertical readout phase; and executing the image processing procedure under the first FPS clock; wherein, the value of the first FPS clock is less than the value of the second FPS clock.

### BACKGROUND OF THE INVENTION

1. Field of the Invention

The present invention relates to a method of accelerating an image processing procedure, and more particularly, to a method of accelerating an image processing procedure by changing the FPS (frame per second).

2. Description of the Related Art

In today's technology, digital image capturing devices are extremely popular devices, and users are demanding increasingly better performance from digital image capturing devices. In general, a digital image capturing device may not perform an image processing procedure at full speed, or at the highest processing frequency, so as to save energy. This may happen when the digital image capturing device performs real-time viewing or static image processing. In the prior art technology, the digital image capturing device continuously performs the image processing procedure at the highest frequency speed, which may lead to poor image quality. Reasons for this include the circuit design, or the use of elements having poor quality. Consequently, the digital image capturing device must execute at lower frequency speeds to obtain better image quality. Under these circumstances, the processing speed of the digital image capturing device is slower.

Therefore, it is desirable to provide a method of accelerating the image processing procedure for a digital image capturing device to mitigate and/or obviate the aforementioned problems.

### SUMMARY OF THE INVENTION

A main objective of the present invention is to provide a method of accelerating an image processing procedure for a digital image capturing device.

In order to achieve the above mentioned objective, the digital image capturing device comprises a processor, a timing generator, and a digital image capturing module. All of the elements are electrically connected to each other. The processor is used to provide all the processing-related functionality of the digital image capturing device. The timing generator is used for controlling the image processing procedure of the digital image capturing device. Generally, the image processing procedure of the digital image capturing module comprises a sweep phase, a vertical readout phase, a horizontal readout phase and a dummy phase. Each phase utilizes the timing generator for control purpose.

The method comprises the steps of: using a second FPS (Frame Per Second) clock to design a pulse of a sweep phase and a pulse of a vertical readout phase; and executing the image processing procedure under the first FPS clock; wherein, the value of the first FPS clock is less than the value of the second FPS clock.

Finally, the dummy phase of the image processing procedure ends the image processing procedure of this frame to enter into the next frame. If the digital image capturing device has remaining data, it will be cleared by the sweep phase for the next frame.

Other objects, advantages, and novel features of the invention will become more apparent from the following detailed description when taken in conjunction with the accompanying drawings.

### BRIEF DESCRIPTION OF THE DRAWINGS

FIG. 1 illustrates the hardware of a digital image capturing device according to the present invention.

FIG. 2 is a schematic drawing of an image processing procedure of a digital image capturing device according to the present invention.

FIG. 3 is a flowchart of a digital image capturing device executing an image processing procedure according to the present invention.

### DETAILED DESCRIPTION OF THE PREFERRED EMBODIMENT

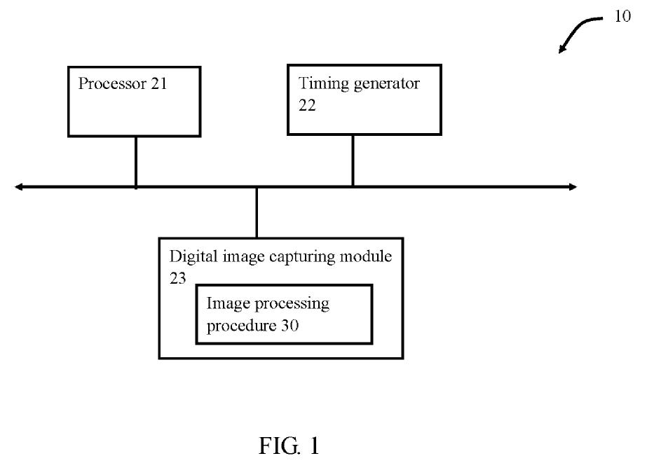

Please refer to FIG. 1. FIG. 1 shows the hardware of a digital image capturing device according to the present invention. A digital image capturing device 10 of the present invention comprises a processor 21, a timing generator 22, a digital image capturing module 23, and other associated components. All of the elements are electrically connected to each other. The processor 21 is used to provide all the processing-related functionality of the digital image capturing device 10. In this embodiment, the digital image capturing module 23 includes a CCD element. The timing generator 22 is used for controlling an image processing procedure 30 of the digital image capturing module 23.

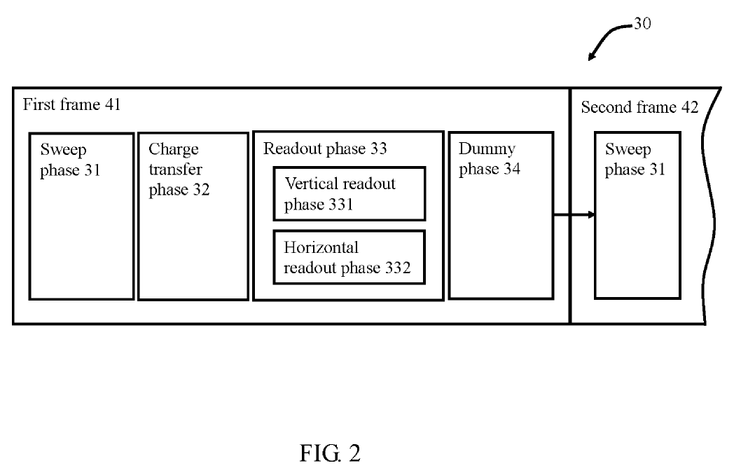

Please refer to FIG. 2. FIG. 2 is a schematic drawing of an image processing procedure of a digital image capturing device according to the present invention.

Generally, the downloading process for each frame of the image processing procedure 30 of the digital image capturing module 23 includes a sweep phase 31, a charge transfer phase 32, a readout phase 33 and a dummy phase 34, as shown by a first frame 41 in the drawing. The sweep phase 31 is used for clearing the remaining data in the previous frame in the image processing procedure 30. The charge transfer phase 32 is used for converting external signals into related charge components, and enabling the readout phase 33 to read out its charge values. The readout phase 33 further comprises a vertical readout phase 331 and a horizontal readout phase 332. The dummy phase 34 is used for ending the processing procedure for the first frame 41, and to move on to a second frame 42.

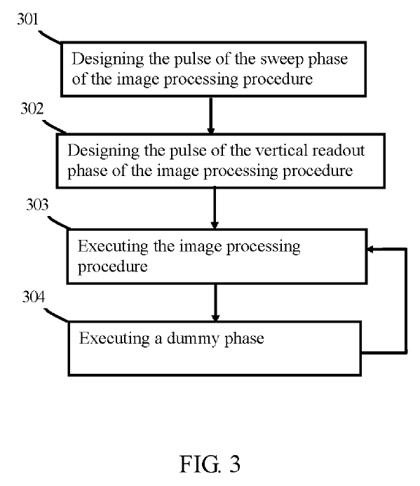

Further, please refer to FIG. 3. FIG. 3 is a flowchart of the digital image capturing device executing the image processing procedure according to the present invention by changing the FPS.

Generally, in order to save energy or to improve image quality, when the timing generator 22 is executing the image processing procedure 30, such as a real time viewing process or a static image process of the digital image capturing module 23, the timing generator 22 does not operate at full speed. For example, the timing generator 22 may use 20 FPS to load the first frame 41, which is not the fastest processing speed of 30 FPS. The method of accelerating the image processing procedure of the present invention can be used for accelerating the downloading time of the image processing procedure 30, such as for the real time view process or the static image process.

The following description explains how the timing generator 22 uses a slower first FPS speed to download the first frame 41, which is not the fastest processing speed (the second FPS speed) of the timing generator 22.

As shown in FIG. 3, the image processing procedure performs step 301 to design the pulse of the sweep phase 31 of the image processing procedure 30; this is done before the digital image capturing device 10 performs the image processing procedure 30.

First, the second FPS clock is used for designing the pulse of the sweep phase 31. The second FPS clock should be longer than the first FPS clock.

Step 302 is performed to design the pulse of the vertical readout phase 331 of the image processing procedure 30.

In a similar manner, the second FPS clock is used for designing the pulse of the vertical readout phase 331.

Generally, due to limitations imposed by the image download execution method of the digital image capturing module 23, no changes can be made during the horizontal readout phase 332. On the other hand, the charge transfer phase 32 does not require too many processing steps, and therefore there is no change in the design of the charge transfer phase 32 in this embodiment.

Step 303 is then performed to execute the image processing procedure 30.

In the first FPS clock, the digital image capturing module 23 executes the image processing procedure 30. The sweep phase 31 and the vertical readout phase 331 of the image processing procedure 30 use the longer second FPS clock for design purposes, and the pulse distances are reduced. Then, the first FPS clock is used to execute the image processing procedure 30, and the sweep phase 31 and the vertical readout phase 331 of the image processing procedure 30 are sped up.

For example, assume the first FPS is 20 FPS and the second FPS is 30 FPS. The processing time for the pulse of the sweep phase 31 and the pulse of the vertical readout phase 331 is calculated based upon the 30 FPS clock; as a result, the pulse distances are shorter. Next, the sweep phase 31 and the vertical readout phase 331 are executed with the 20 FPS clock. Therefore, the processing time of the sweep phase 31 and the vertical readout phase 331 is reduced by about one third. Furthermore, the entire processing time of the digital image capturing module 23 is reduced, which accelerates the entire processing speed.

Step 304 is performed to execute a dummy phase 34.

Finally, the dummy phase 34 of the image processing procedure 30 is executed. The dummy phase 34 directly terminates the image processing procedure 30 of the first frame 41 to proceed to the second frame 42. Step 303 is then repeated to execute the image processing procedure 30 for the second frame 42. If the digital image capturing module 23 has some remaining image data, the sweep phase 31 of the second frame 42 is used for purging the data to reduce the processing time.

Although the present invention has been explained in relation to its preferred embodiment, it is to be understood that many other possible modifications and variations can be made without departing from the spirit and scope of the invention as hereinafter claimed.

What is claimed is:

1. A method of accelerating an image processing procedure for a digital image capturing device, the digital image capturing device executing an image processing procedure under a first FPS (Frame Per Second) clock, the method comprising:
using a second FPS clock to design at least one processing phase of the image processing procedure; and
executing the image processing procedure under the first FPS clock; wherein, the value of the first FPS clock is less than the value of the second FPS clock.

2. The method as claimed in claim 1 further comprising using the second FPS clock to design a pulse for a sweep phase of the image processing procedure.

3. The method as claimed in claim 1 further comprising using the second FPS clock to design a pulse of a vertical readout phase of the image processing procedure.

4. The method as claimed in claim 1 further comprising executing a dummy phase to end the image processing procedure.

5. The method as claimed in claim 1, wherein the first FPS is 20 FPS and the second FPS is 30 FPS.

6. A digital image capturing device with an accelerated image processing capability, the digital image capturing device comprising:
a processor;
a digital image capturing module electrically connected to the processor for executing an image processing procedure; and
a timing generator electrically connected to the digital image capturing module; the processor controlling the timing generator and the digital image capturing module to achieve the following means in a first FPS clock:
using a second FPS clock to design at least one processing phase of the image processing procedure; and
executing the image processing procedure under the first FPS clock; wherein, the value of the first FPS clock is less than the value of the second FPS clock.

7. The digital image capturing device as claimed in claim 6, wherein the image processing procedure comprises a sweep phase.

8. The digital image capturing device as claimed in claim 7, wherein the second FPS clock is used to design the sweep phase.

9. The digital image capturing device as claimed in claim 6, wherein the image processing procedure comprises a vertical readout phase.

10. The digital image capturing device as claimed in claim 9, wherein the second FPS clock is used for designing the vertical readout phase.

11. The digital image capturing device as claimed in claim 6, wherein the image processing procedure comprises a horizontal readout phase.

12. The digital image capturing device as claimed in claim 6, wherein the image processing procedure comprises a dummy phase.

13. The digital image capturing device as claimed in claim 12, wherein the dummy phase is used for ending the image processing procedure.

14. The digital image capturing device as claimed in claim 6, the first FPS is 20 FPS and the second FPS is 30 FPS.
